(19) United States
(12) Patent Application Publication
(10) Pub. No.: US 2014/0259599 A1
(43) Pub. Date: Sep. 18, 2014

(54) TORQUE GUN WITH VISION SYSTEM

(71) Applicants: Jared L. Glaspell, Columbus, OH (US); Brent Allen Bowers, Muscatine, IA (US); Mengtang Sun, Dayton, OH (US); Zewen Yu, Dayton, OH (US); Xin Zhang, Dayton, OH (US); Richard J. Barr, Kettering, OH (US); Kevin P. Swanger, Kansas City, MO (US)

(72) Inventors: Jared L. Glaspell, Columbus, OH (US); Brent Allen Bowers, Muscatine, IA (US); Mengtang Sun, Dayton, OH (US); Zewen Yu, Dayton, OH (US); Xin Zhang, Dayton, OH (US); Richard J. Barr, Kettering, OH (US); Kevin P. Swanger, Kansas City, MO (US)

(73) Assignee: HONDA MOTOR CO., LTD., Tokyo (JP)

(21) Appl. No.: 13/949,809

(22) Filed: Jul. 24, 2013

Related U.S. Application Data
(60) Provisional application No. 61/791,367, filed on Mar. 15, 2013.

(51) Int. Cl. B23Q 17/24; B25B 21/00

(52) U.S. Cl. CPC B23Q 17/2409; B23Q 17/2404; B25B 21/00
USPC 29/407.04; 173/46; 173/1

(57) ABSTRACT

A hand-held torque tool includes a hand tool chassis and a vision system. The hand tool chassis includes a motor configured to operate a work head and a camera located in a fixed position relative to the work head. The vision system includes a wireless controller which transmits images captured by the camera, a wireless display located remotely from the hand tool chassis that is configured to display images captured by the camera, and a mounting structure attached to the wireless display. The mounting structure is configured to be placed on or about a portion of a body of a user of the hand-held torque tool. Methods of tightening a fastener and installing automobile components within an automobile are also provided.

### BACKGROUND

The present disclosure relates generally to installing fasteners in relatively confined spaces, and more particularly, to an apparatus and methods for installing fasteners with a hand-held fastener tool.

Fasteners for devices, particularly those for complicated machinery, can often be located in relatively confined spaces. For example, internal components of an automobile require fastening during the automobile assembly process. This part of the assembly process can often require an assembly worker to place his or her head and a portion of his or her torso into the vehicle in order to visually locate a particular fastener, engage a hand-held fastener tool with the fastener, and fasten one or more components. This portion of the assembly process can be time consuming, and can also force the assembly worker to place his or her body into awkward positions. Current methods for fastening some automobile internal components include positioning of an assembly worker's body partially within the automobile interior to gain a direct line of sight of the fastener and using a fastener or torque tool to fasten the component. Accordingly, it would be beneficial to provide a torque tool with a vision system enabling a user to fasten a component in a relatively confined space while limiting or eliminating the placement of his or her body within the confined space.

### SUMMARY

The following presents a simplified summary in order to provide a basic understanding of some example aspects of the disclosure. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

In accordance with one aspect, a hand-held torque tool is provided. The hand-held torque tool includes a hand tool chassis and a motor located within the hand tool chassis. The motor is configured to operate a work head. The hand-held torque tool also includes a camera attached to the hand tool chassis in a fixed position relative to the work head. The hand-held torque tool further includes a vision system. The vision system includes a wireless controller that transmits images captured by the camera. The vision system also includes a wireless display located remotely from the hand tool chassis. The wireless display is configured to display images captured by the camera. The vision system further includes a mounting structure including the wireless display. The mounting structure is configured to be placed on or about a portion of a body of a user of the hand-held torque tool.

In accordance with another aspect, a method of tightening a fastener is provided. The method includes the step of providing a fastener. The method also includes the step of providing a hand-held torque tool. The hand-held torque tool includes a hand tool chassis and a motor located within the hand tool chassis. The motor is configured to operate a work head. The hand-held torque tool also includes a camera attached to the hand tool chassis in a fixed position relative to the work head. The hand-held torque tool further includes a vision system. The vision system includes a wireless controller that transmits images captured by the camera. The vision system also includes a wireless display located remotely from the hand tool chassis. The wireless display is configured to display images captured by the camera. The vision system further includes a mounting structure including the wireless display. The mounting structure is configured to be placed on or about a portion of a body of a user of the hand-held torque tool. The method further includes the step of orienting the hand-held torque tool toward the fastener. The method still further includes the step of viewing the fastener via images shown on the wireless display to engage the work head with the fastener. The method also includes the step of applying a torque to the fastener.

In accordance with another aspect, a method of installing an automobile component within an automobile is provided. The method includes the step of providing a fastener. The method also includes the step of providing a hand-held tool. The hand-held torque tool includes a hand tool chassis and a motor located within the hand tool chassis. The motor is configured to operate a work head. The hand-held torque tool also includes a camera attached to the hand tool chassis in a fixed position relative to the work head. The hand-held torque tool further includes a vision system. The vision system includes a wireless controller attached to the hand tool chassis. The wireless controller transmits images captured by the camera. The vision system also includes a wireless display located remotely from the hand tool chassis. The wireless display is configured to display images captured by the camera. The vision system further includes a mounting structure including the wireless display. The mounting structure is configured to be placed on or about a portion of a body of a user of the hand-held torque tool. The method further includes the step of viewing the work head and the fastener via images shown on the wireless display to position the work head proximate to the fastener. The method also includes the step of engaging the work head with the fastener. The method still further includes the step of at least partially installing the automobile component to the automobile.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a perspective view of an example hand tool chassis and camera mounted to the chassis according to at least one aspect of the present disclosure;

FIG. 2 is a perspective view of an example hand held torque tool including the hand tool chassis of FIG. 1 in addition to a vision system;

FIG. 3 is a perspective view of the example hand held torque tool of FIG. 2 being used to fasten a dashboard component in an automobile interior; and

FIG. 4 is a flow chart depicting a method of tightening a fastener.

### DETAILED DESCRIPTION

Example embodiments that incorporate one or more aspects of the present disclosure are described and illustrated in the drawings. These illustrated examples are not intended to be a limitation on the present disclosure. For example, one or more aspects of the present disclosure can be utilized in other embodiments and even other types of devices. Moreover, certain terminology is used herein for convenience only and is not to be taken as a limitation. Still further, in the drawings, the same reference numerals are employed for designating the same elements. For the purposes of this disclosure, the terms “user” and “operator” are used to indicate the person utilizing the described structure and methods. The terms are used interchangeably.

FIGS. 1-2 illustrate a perspective view of an example hand-held fastener or torque tool 10. As a general description prior to a more detailed description, the hand-held torque tool 10 can manipulate fasteners that may be located in confined spaces or otherwise located in positions that are somewhat difficult to reach.

The hand-held torque tool 10 includes a hand tool chassis 14 and a vision system 70. The hand tool chassis 14 can be constructed of any number of suitable materials including various metal alloys, molded plastics, etc. In one example, as shown in FIG. 1, the hand tool chassis 14 can include three portions: a battery portion 16, a handle portion 18, and a top portion 20. The battery portion 16 can be configured to include a battery 24 within or attached to the hand tool chassis 14. The battery 24 can hold an electrical charge which can be depleted by operating the hand-held torque tool 10 as will be described below. In one example, the hand-held torque tool 10 can be placed in a battery charging unit to replenish the electrical charge within the battery 24. In another example, the battery 24 can be removed from the hand-held torque tool 10 and placed in a battery charging unit while a separate, charged battery can be used with the hand-held torque tool 10. While the shown example in FIG. 1 illustrates the battery 24 located within the battery portion 16, a removable battery can constitute all or most of the battery portion 16. It is to be appreciated that the battery 24 can include any suitable type of battery. In another example, the battery 24 can be designed to hold a charge sufficient to operate for a predetermined time, such as two to three hours, prior to requiring additional charge. Of course, this design would also have to account for the required work output the battery 24 is expected to output within the predetermined time.

The handle portion 18 can be located centrally relative to the battery portion 16 and the top portion 20 and interconnect the battery portion 16 to the top portion 20. Configuration of the handle portion 18 can include various ergonomic features to enhance a user's grip on the hand-held torque tool 10. Such ergonomic features can include molded areas to fit a user's hand, relatively soft or pliable coatings on the handle portion 18, etc. The handle portion can also include a user-operated switch, such as trigger 26. Trigger 26 can serve as a switch in at least one electrical connection (not shown) between the battery 24 and components in the top portion 20 which will be described below. Other electrical connections can also pass through the handle portion 18, and these electrical connections will also be described below.

The top portion 20 can include a main section 28 and an end effector 30. In one example, the main section 28 can be generally cylindrical extending generally away from the interconnection with the handle portion 18 and toward the end effector 30. A motor 34 is located within the hand tool chassis 14. In the shown example of FIG. 1, the motor 34 is located within the main section 28 of the top portion 20 of the hand tool chassis 14. It is to be appreciated that other motor locations are also contemplated within the scope of this disclosure.

The end effector 30 can act as a cap-like device for the top portion 20. The end effector 30 can include a mount 36 for the proximal end 38 of a work head 40 (best seen in FIG. 2). The mount 36 is shown schematically in FIG. 1 and can include any number of configurations of work head mounting arrangements. For example, the mount 36 can define a hexagonal cavity that accepts a hexagonal shaft of the work head 40. In another example, a magnet can be included within the mount 36 to help secure the proximal end 38 of the work head 40 in the mount 36. Other examples of the mount 36 can include a jaw with multiple teeth that move radially to firmly grip the work head 40 or a “quick disconnect” configuration. Regardless of the selected configuration of the mount 36, the mount 36 is configured to create a relatively firm attachment between the mount 36 and the work head 40. In a further example, the mount 36 can be configured to selectively release the work head 40 in order to utilize another work head with the hand-held torque tool 10. Placement of the work head 40 within the mount 36 can establish a work head axis 44 that can be co-linear with a central axis of the work head 40.

The motor 34 is configured to operate the work head 40. In one example, the user of the hand-held torque tool 10 can actuate the trigger 26, thereby providing an electrical connection (not shown) between the battery 24 and the motor 34. As the trigger 26 is actuated, the electrical connection between the battery 24 and the motor 34 enables electrical energy to travel from the battery 24 to the motor 34. Electrical energy can then cause a motion in the motor, such as component rotation. The component rotation can then operate the work head 40, such as by urging a rotation of the work head 40. For example, the component rotation can be used to rotate the mount 36 which can then rotate the work head 40.

The work head 40 can be configured to apply a torque to a fastener 46 (best seen in FIG. 3). In one example, the distal end 48 of the work head 40 is configured to apply a torque to the fastener 46 by including structure that corresponds to structure on the fastener 46. This corresponding structure can be any number of structures such as regular (slotted) driver, Phillips driver, hex head, star drive, and any number of other configurations, including specialized configurations that may be proprietary to particular manufacturers. Complimentary structure included on both the fastener 46 and the distal end 48 of the work head 40 can then interact so that rotation of the work head 40 urges the fastener 46 to rotate. As such, component rotation in the motor 34 can rotate the mount 36 which then rotates work head 40, causing rotation of the fastener 46.

In another example, the hand-held torque tool 10 can be configured to apply a fixed torque value to the fastener 46 through the work head 40. For example, a sensor (not shown) can detect the amount of voltage being drawn from the battery 24 by the motor 34. As the motor 34 rotates the mount 36, work head 40, and the fastener 46, the amount of voltage drawn from the battery 24 increases as the fastener 46 is rotated with greater torque. The sensor can relay the voltage draw information to a controller (not shown) which can then limit the voltage supply to the motor 34 to thereby limit the driving torque of the hand-held torque tool to a fixed, predetermined value. In one particular example, the fixed torque value applied to the fastener 46 is about 1.9 to 2.5 kilogram-meters (kg-m) (13.7 to 18.1 foot-pounds (ft-lbs)).

A camera 54 is attached to the hand tool chassis 14. As shown in the example hand-held torque tool 10 of FIG. 1, the camera 54 can be located on the end effector 30. Regardless of the location of the camera 54, the camera 54 is located in a fixed position relative to the work head 40. A viewing direction of the camera 54 can be termed a camera line of sight 56 as shown in FIG. 1, and can extend away from the camera 54 in a direction substantially similar to the work head axis 44. In one particular example, the camera 54 is located such that the camera line of sight 56 is positioned at a non-zero angle 58 with respect to the work head axis 44. Location of the camera 54 can be predetermined such that the angle 58 creates an intersection of the camera line of sight 56 and the work head axis 44 at a location relatively close to the end of the work head 40. In one example, the camera 54 is located in a fixed position such that the angle 58 is not adjustable. In a further example, the camera 54 can be adjusted such that the location of the intersection of the camera line of sight 56 and the work head axis 44 can be adjusted for work heads 40 of various lengths and/or configurations. The camera 54 can be provided with an electrical connection through the hand tool chassis 14 to the battery 24 in order to draw electrical power for operation.

The camera 54 can be configured to capture images of the fastener 46 and the work head 40. Images of the fastener 46 and the work head 40 enable the user to view the distal end 48 of the work head 40 and/or the fastener 46 without having a direct line of sight of either the work head 40 or the fastener 46. This can be useful for a user who must operate the fastener 46 while it is in an enclosed or confined space that hinders or prohibits the user from having ready access to directly view the work head 40 and/or the fastener 46. The images can be displayed for the user to view as will be described below. These described images help the user engage the distal end 48 of the work head 40 with the fastener 46 and operate the fastener 46 without having a direct line of sight. As such, the images enable the user to view at least a portion of the work head 40 and the fastener 46 remotely and operate the fastener 46 without being able to directly see the fastener. In one example, the images captured by the camera 54 include moving pictures.

The hand-held torque tool 10 can also include a light 64, represented schematically in FIG. 1. The light 64 can help illuminate an area around the distal end 48 of the work head 40, such that the user of the hand-held torque tool 10 can more readily see the fastener 46 and the positional relationship between the fastener 46 and the distal end 48 of the work head 40. In one example, the light 64 can be illuminated upon actuation of the trigger 26. In another example, the light 64 can be illuminated upon activation of a switch (not shown) dedicated to operation of the light such that the light 64 can be illuminated and remain illuminated at the discretion of the user, even while not operating the motor 34. The light 64 can draw electrical power from the battery 24 via an electrical connection (not shown) through the main section 28 of the top portion 20, the handle portion 18, and the battery portion 16 to the battery 24. The light 64 can include any suitable light source such as incandescent, light emitting diode (LED), etc.

The hand-held torque tool 10 can also include a laser 66, represented schematically in FIG. 1. The laser 66 can provide targeting assistance for the user of the hand-held torque tool 10. For example, the laser 66 can illuminate a pinpoint of light on an object a distance away from the distal end 48 of the work head 40. The pinpoint of light can indicate to the user the orientation of the work head 40 and/or the work head axis 44 as the user moves the distal end 48 of the work head 40 toward a fastener 46. The user can then make adjustments to the path of motion of the hand-held torque tool 10 in order to mate the distal end 48 of the work head 40 with the fastener 46 (best seen in FIG. 3). While the light emanating from the laser 66 is described above as a pinpoint, it is to be appreciated that the laser 66 can be configured to create a line of laser light, a crosshairs pattern, or any other suitable pattern. Similar to the light 64, the laser 66 can be provided with an electrical connection through the hand tool chassis 14 to the battery 24 in order to draw electrical power for operation. The laser 66 can include any suitable laser light source.

Turning now to FIG. 2, the hand-held torque tool 10 further includes the vision system 70. The vision system 70 includes a wireless controller 74 which can be provided within the hand tool chassis 14 or within a separate enclosure 76. The wireless controller 74 and the enclosure 76 can be mounted to the hand-held torque tool 10 at any suitable location. For example, FIG. 1 shows an example enclosure 76 mounted on the rear side of the battery portion 16 while FIG. 2 shows another example enclosure 76 mounted to the right side of the battery portion 16. Other suitable enclosure 76 locations are also contemplated. The enclosure 76 can also include a removable portion such as a door 78 which enables user access to the wireless controller 74 as needed.

The wireless controller 74 wirelessly transmits images captured by the camera 54. The camera 54 can be provided with an electrical connection through the hand tool chassis 14 to the wireless controller 74 in order to send electrical representations of images captured by the camera 54 to the wireless controller 74. In one example, the wireless controller 74 can wirelessly transmit the images at a particular frequency. The transmission frequency can be selected so as avoid interference with other electromagnetic frequencies utilized in the general vicinity of the hand-held torque tool 10. For example, the wireless controller 74 can be configured to transmit images in wireless ranges of 802 A, 7 GHz, 2.4 GHz, or a Bluetooth frequency range of about 2400 to 2480 MHz. It is to be appreciated that any suitable transmission frequency can be used.

The vision system 70 also includes a wireless display 80 located remotely from the hand tool chassis 14. The wireless display 80 is configured to receive the images captured by the camera 54 and wirelessly transmitted by the wireless controller 74. The wireless display 80 is also configured to display the images captured by the camera 54 and wirelessly transmitted by the wireless controller 74. In one example, moving pictures are displayed on the wireless display 80 as they are captured by the camera 54. Displaying moving pictures on the wireless display 80 as they are captured can be termed “in real time” or “live action.” In other words, as the operator moves the hand-held torque tool 10 and the camera 54 captures images, those images are simultaneously or nearly simultaneously displayed on the wireless display 80. Any suitable display structure can be used for the wireless display including, but not limited to, LED displays, liquid crystal displays (LCD), etc. As shown in FIG. 2, the wireless display 80 can include user interface structure such as buttons 84. The buttons can be used to control various aspects of the wireless display 80 and/or the image displayed on the wireless display 80.

The vision system 70 further includes a mounting structure attached to the wireless display 80. The mounting structure is configured to be placed on or about a portion of a body (e.g., hand, wrist, arm, head, etc.) of a user of the hand-held torque tool 10. In one example, the mounting structure can be at least one strap or band 86 attached to the wireless display 80. The band 86 is configured to be placed about a wrist or arm of an operator of the hand-held torque tool 10. As shown in FIG. 3, the operator can fasten the wireless display 80 onto his or her arm 88 using the band 86. In one example, the operator places the wireless display 80 on the same arm 88 that is holding the hand-held torque tool 10. The wireless display 80 may also be incorporated into or held by the mounting structure.

It is to be appreciated that the location and weights of the various components of the hand-held torque tool 10 can be determined so as to include good practices of ergonomic design. For example, the hand tool chassis 14 can have a weight distribution that is relatively balanced between the battery portion 16 and the top portion 20 such that neither portion weighs considerably more than the other portion. In another example, the weight of the hand tool chassis 14 and all of the components attached to it are not more than a desired weight, such as about 2.3 kilograms (kg) or about 5 pounds (lbs).

Other design considerations for the hand-held torque tool 10 can include those that make the hand-held torque tool 10 compatible with its work environment. In one example, the hand-held torque tool 10 is used in an automobile assembly environment. The hand-held torque tool 10 can include chamfered corners to eliminate or reduce the possibility of scratching of the automobile exterior surfaces. In another example, the hand-held torque tool 10 can be designed to withstand an impact after falling from a typical operating height (e.g., four to five feet).

This described arrangement enables an operator to place the hand-held torque tool 10 into a space having limited access, watch the images on the wireless display 80 located on his or her arm 88, and operate a fastener 46, such as applying a torque to the fastener 46 in order to tighten the fastener 46. In one example, the space having limited access includes an automobile interior on an automobile assembly line, however, the described hand-held torque tool 10 can be used in any number of locations having limited access for an operator, and is not limited to automobile interiors. Much of the remainder of the disclosure will describe the use of the hand-held torque tool 10 in reference to an automobile interior. It is to be appreciated that the automobile interior shown in FIG. 3 is somewhat generically depicted. Indeed, the depicted automobile interior can represent a number of different vehicles that may have several interior components requiring attachment installation during automobile assembly. As such, the hand-held torque tool 10 can be used in a variety of vehicular applications or other applications.

As illustrated in FIG. 3, an operator from time to time, during the assembly of an automobile, is required to secure any number of components such as dashboard components, pedal brackets, etc. It can be relatively difficult for an operator (e.g., an assembly line worker) to insert his or her upper body into the automobile interior such that he or she can gain a direct line of sight to fasten these components into place. The described hand-held torque tool 10 enables the operator to extend his or her arm and relatively little of his or her torso into the automobile interior while still being able to view and fasten components within the interior. This is due to the lack of need for the operator to have a direct line of sight of the fastener 46. The hand-held torque tool 10 enables the operator to view the work head 40 approach and engagement with the fastener 46 on the wireless display 80 that is worn on a portion of his arm. In one example, the operator can remain standing on the assembly area floor and apply a torque to a fastener 46 while limiting the amount of the torso and upper body required to be positioned within the automobile interior.

With reference to FIG. 4, methods of tightening a fastener will now be described. One example method includes the step 120 of providing a fastener. As described above, the fastener can include any type of suitable fastener including screws and similar fasteners that require a torque to fasten or unfasten the fastener.

The method also includes the step 130 of providing a hand-held torque tool. The hand-held torque tool includes a hand tool chassis and a motor located within the hand tool chassis. The motor is configured to operate a work head. In one example, the distal end of the work head is configured to apply a torque to the fastener by including a structure that corresponds to structure on the fastener. A camera is attached to the hand tool chassis in a fixed position relative to the work head. The camera captures images of the work head and/or the fastener. In one example, the images include moving pictures. The hand-held torque tool also includes a vision system. The vision system includes a wireless controller within or attached to the hand tool chassis. The wireless controller transmits images captured by the camera. The vision system further includes a wireless display located remotely from the hand tool chassis. The wireless display is configured to display images captured by the camera. In one example of the method, moving pictures are displayed on the wireless display as they are captured by the camera. The vision system still further includes a mounting structure attached to the wireless display. The mounting structure is configured to be placed on or about a body of a user of the hand-held torque tool. In one example, the mounting structure includes a band used to attach the wireless display to a portion of the user's arm.

The method further includes the step 140 of orienting the hand-held torque tool toward the fastener. As the user proceeds to fasten components within an automobile interior, he or she reaches into the automobile interior while holding the hand-held torque tool. The user then aims the hand-held torque tool toward the fastener in order to engage the work head with the fastener.

The method still further includes the step 150 of viewing the work head and the fastener via images shown on wireless display. By viewing the images, the user can determine how to maneuver the hand-held torque tool in order to position the work head proximate to the fastener. In one example, as described above, the images can include moving pictures shown in real time such that the movement of the work head relative to the fastener are displayed simultaneously or near simultaneously on the wireless display.

The method also includes the step 160 of viewing the work head and the fastener via images shown on the wireless display to engage the work head with the fastener. Utilizing the wireless display, the user need not have a direct line of sight of the work head or the fastener, and the user may rely upon the images on the wireless display to maneuver the work head to a proximate position to the fastener, and, ultimately, into engagement with the fastener.

The method also includes the step 170 of applying a torque to the fastener. A torque is developed by the motor in the top portion and transferred through the mount, the work head, and to the fastener. The torque can be applied to fasten or unfasten the fastener. In one example, the method can further include the step of at least partially installing an automobile component to the automobile. The fastener interacts with the automobile component and a portion of the automobile in order to install the component.

In another example, the hand-held torque tool applies a fixed torque value to the fastener. The torque can be limited in any number of ways, including limiting the voltage signal supplied from the battery to the motor, physically limiting the torque, etc.

Further examples of the method can include the step of disengaging the work head from the fastener. The user can then apply a torque to other fasteners located within the automobile interior or the user can retract his or her body and the hand-held torque tool from the automobile interior to move to the next automobile in the assembly process.

The described hand-held torque tool and associated methods can include several benefits. The device includes an ergonomic design specific to posture which can eliminate the awkward positions which can develop from an automobile assembly worker placing a portion of his or her head and torso within the interior of an automobile in order to apply a torque to fasteners within the automobile interior. In one example, the hand-held torque tool and associated methods can improve the ergonomics of the assembly process of applying a torque to a fastener within an automobile interior.

Additionally, the battery-powered hand-held torque tool can eliminate the need to have electric supply cords or pneumatic hose attached to the tool, which is often the case with current torque tools. Elimination of the electric supply cords and/or pneumatic hose increases the ease with which the automobile assembly worker can complete his or her job during application of torque to fasteners within the automobile interior. Furthermore, the described hand-held torque tool enables a user to view a fastener that is located in a blind hole, is not viewable when a torque tool is moved into position to engage the fastener, or is otherwise blocked from view. Being able to view the fastener as the torque tool approaches and engages the fastener increases the ability of the user to engage the fastener and properly apply a torque to the fastener, such as in automotive component installation procedures.

The disclosure has been described with reference to the example embodiments described above. Modifications and alterations will occur to others upon a reading and understanding of this specification. Example embodiments incorporating one or more aspects are intended to include all such modifications and alterations insofar as they come within the scope of the appended claims.

What is claimed is:

1. A hand-held torque tool comprising:
a hand tool chassis;
a motor located within said hand tool chassis, wherein said motor is configured to operate a work head;
a camera attached to said hand tool chassis in a fixed position relative to said work head; and
a vision system comprising:
a wireless controller, wherein said wireless controller transmits images captured by said camera;
a wireless display located remotely from said hand tool chassis, wherein said wireless display is configured to display images captured by said camera;
a mounting structure including said wireless display, wherein said mounting structure is configured to be placed on or about a portion of a body of a user of said hand-held torque tool.

2. The hand-held torque tool according to claim 1, wherein said work head is configured to apply a torque to a fastener.

3. The hand-held torque tool according to claim 2, wherein said hand-held torque tool is configured to apply a fixed torque value to said fastener through said work head.

4. The hand-held torque tool according to claim 2, wherein said camera is configured to capture images of said fastener and said work head.

5. The hand-held torque tool according to claim 1, wherein said images comprise moving pictures.

6. The hand-held torque tool according to claim 5, wherein said moving pictures are displayed on said wireless display as they are captured by said camera.

7. The hand-held torque tool according to claim 1, further comprising a light.

8. The hand-held torque tool according to claim 1, further comprising a laser.

9. The hand-held torque tool according to claim 1, wherein a line of sight of said camera is positioned at a non-zero angle with respect to an axis of said work head.

10. A method of tightening a fastener, said method comprising the steps of:
providing a fastener;
providing a hand-held torque tool comprising: a hand tool chassis, a motor located within said hand tool chassis, wherein said motor is configured to operate a work head, a camera attached to said hand tool chassis in a fixed position relative to said work head, and a vision system comprising: a wireless controller, wherein said wireless controller transmits images captured by said camera, a wireless display located remotely from said hand tool chassis, wherein said wireless display is configured to display images captured by said camera, a mounting structure including said wireless display, wherein said mounting structure is configured to be placed on or about a body of a user of said hand-held torque tool;
orienting said hand-held torque tool toward said fastener;
viewing said fastener via images shown on said wireless display to engage said work head with said fastener; and
applying a torque to said fastener.

11. The method of claim 10, further including the step of disengaging said work head from said fastener.

12. The method of claim 10, wherein said hand-held torque tool applies a fixed torque value to said fastener.

13. The method of claim 10, wherein said images comprise moving pictures.

14. The method of claim 13, wherein said moving pictures are displayed on said wireless display as they are captured by said camera.

15. The method of claim 10, wherein said hand-held torque tool further includes a light.

16. The method of claim 10, wherein a line of sight of said camera is positioned at a non-zero angle with an axis of said work head.

17. A method of installing an automobile component within an automobile, said method comprising the steps of:
providing a fastener;
providing a hand-held tool comprising: a hand tool chassis, a motor located within said hand tool chassis, wherein said motor is configured to operate a work head, a camera attached to said hand tool chassis in a fixed position relative to said work head, and a vision system comprising: a wireless controller attached to said hand tool chassis, wherein said wireless controller transmits images captured by said camera, a wireless display located remotely from said hand tool chassis, wherein said wireless display is configured to display images captured by said camera, a mounting structure including said wireless display, wherein said mounting structure is configured to be placed on or about a body of a user of said hand-held torque tool;
viewing said work head and said fastener via images shown on said wireless display to position said work head proximate to said fastener;
engaging said work head with said fastener; and
at least partially installing said automobile component to said automobile.

18. The method of claim 17, wherein said hand-held tool applies a fixed torque value to said fastener.

19. The method of claim 17, wherein said images comprise moving pictures.

20. The method of claim 19, wherein said moving pictures are displayed on said wireless display as they are captured by said camera.
